(19) United States
(12) Patent Application Publication
(10) Pub. No.: US 2019/0101054 A1
(43) Pub. Date: Apr. 4, 2019

(54) FILTER ELEMENT FOR A CONNECTING ROD AND CONNECTING ROD FOR AN INTERNAL COMBUSTION ENGINE WITH VARIABLE COMPRESSION

(71) Applicant: ECO HOLDING 1 GMBH, Marktheidenfeld (DE)

(72) Inventors: Alexander Mudra, Goerlitz (DE); Dietmar Schulze, Muenzenberg (DE)

(21) Appl. No.: 16/149,814

(22) Filed: Oct. 2, 2018

(30) Foreign Application Priority Data
Oct. 4, 2017 (DE) 102017122929.9
Mar. 7, 2018 (DE) 102018105247.2

(51) Int. Cl. F02B 75/04; F02D 15/02; B01D 35/02; B01D 29/01; F15B 11/10

(52) U.S. Cl. CPC F02B 75/045; F02D 15/02; F15B 2211/615; B01D 29/01; F15B 11/10; B01D 35/02

(57) ABSTRACT

A filter element for a connecting rod including an eccentrical element adjustment arrangement for adjusting an effective connecting rod length, the filter element comprising a bushing that is flowable by a hydraulic fluid along a fluid path; and at least one screen insert that is arranged in the fluid path of the bushing. The invention also relates to a connecting rod with at least one filter element.

### RELATED APPLICATIONS

This application claims priority from and incorporates by reference German patent applications
DE 10 2017 122 929.9 filed on Oct. 4, 2017, and
DE 10 2018 105 247.2 filed on Mar. 7, 2018.

### FIELD OF THE INVENTION

The invention relates to a filter element for a connecting rod, in particular a connecting rod for adjusting an effective connecting rod length and a connecting rod for a variable compression internal combustion engine with the filter element.

### BACKGROUND OF THE INVENTION

In internal combustion engines a high compression ratio has a positive effect upon an efficiency of the internal combustion engine. Compression ratio is typically defined as a ratio of an entire cylinder cavity before compression to a remaining cylinder cavity after compression. In internal combustion engines with external ignition, in particular gasoline engines that have a fixed compression ratio, the compression ratio, however, may only be selected high enough so that a so-called “knocking” of the internal combustion engine is prevented during full load operations. However, for much more prevalent partial load operations of the internal combustion engine, thus for a lower cylinder charge the compression ratio can be selected at a higher level without “knocking” occurring. The important partial load operations of an internal combustion engine can be improved when the compression ratio is variably adjustable. In order to adjust the compression ratio systems with variable connecting rod length are known.

A connecting for a variable compression internal combustion engine with an eccentrical element adjustment arrangement for adjusting an effective connecting rod length and a hydraulic arrangement are known for example from DE 10 2012 020 999 A1.

### BRIEF SUMMARY OF THE INVENTION

It is an object of the invention to provide a filter element for a connecting rod with an eccentrical element adjustment arrangement for adjusting an effecting connecting rod length which has stable operating properties.

It is another object of the invention to provide an improved connecting rod for a variable compression internal combusting engine with the filter element that has stable operating properties.

The object is achieved by a filter element for a connecting rod including an eccentrical element adjustment arrangement for adjusting an effective connecting rod length, the filter element comprising a bushing that is flowable by a hydraulic fluid along a fluid path; and at least one screen insert that is arranged in the fluid path of the bushing.

Advantageous embodiments of the invention can be derived from the dependent claims, the description and the drawing figure.

According to an aspect of the invention a filter element is proposed for a connecting rod with an eccentrical element adjustment arrangement for adjusting an effective connecting rod length, the filter element comprising a bushing that is flowable by a hydraulic fluid along a fluid path and at least one screen insert that is arranged in the fluid path of the bushing.

According to the invention the screen insert is introduced into the bushing which provides an effective filter element in the fluid path of the eccentrical element adjustment arrangement of a connecting rod. The screen insert can be a sheet metal element which can be flowed through in both directions transversal to a surface of the screen insert by a hydraulic fluid like, e.g., motor oil. Thus, the oil can be filtered in an interface between the connecting rod and the crank pin of the internal combustion engine. Thus, the eccentrical element adjustment arrangement can be protected against contaminations from the crank shaft portion of the internal combustion engine and the internal combustion engine can be protected from abrasion particles from the eccentrical element adjustment arrangement which achieves a high service life for the connecting rod and the internal combustion engine.

The screen insert can be provided for example as a perforated plate wherein the holes can be introduced by laser processing. The screen insert can also be provided as a wire mesh or as a synthetic material injection molded component with an insert made from wire mesh.

The screen insert can be impressed into the bushing, snap locked, threaded or attached in another suitable manner. For snap locking a lug can be advantageously provided at an outside of the bushing. In case a press fit is not suitable for reasons of tolerances, the screen insert, however, can also be welded into the bushing.

The filter element can be inserted as a complete subassembly into a connecting rod cover of the connecting rod, e.g., pressed in or threaded in.

Since the screen insert can be flowed through by the oil in both directions and is thus flushed over and over again. Therefore the filter element is provided self-purging.

In an advantageous embodiment screen inserts can be respectively arranged at both ends of the bushing in order to obtain an advantageous filtering effect for the hydraulic fluid that flows through.

According to an advantageous embodiment the at least one screen insert can be arranged at a face of the bushing. From a face of the bushing the screen insert can be advantageously pressed in so that the screen insert is secured by a press fit against falling out of the bushing during operations. Additionally or advantageously the screen insert can also be welded in at the face of the bushing so that the screen insert is permanently secured against falling out.

According to an advantageous embodiment the bushing can include a throttling location along the fluid path through the bushing. The throttling location can be advantageously provided as an aperture in the bushing which is integrated into the bushing as an additional component or which is configured as a portion of the bushing. The throttling location can advantageously function as a smallest aperture in the hydraulic supply of the eccentrical element adjustment arrangement functioning as a throttle for generating a hydraulic preload of a hydraulic chamber of the eccentrical element adjustment arrangement. Thus the throttling location can be configured as a precise aperture, e.g., machined on both sides or provided with a cone in order to be as close as possible to an ideal aperture with zero height. Advantageously a ratio of length in flow-through direction to diameter of the aperture opening in a range of 3, in particular up to 1, can be implemented.

Thus a viscosity independent flow-through of the filter element with the throttle function is an essential advantage of this aperture.

According to an advantageous embodiment the throttling location can be integrated into the bushing. The throttling location can be implement for example as a contraction of the free cross-section of the bushing. The throttling location can be configured as a conical aperture in an interior of the bushing in order to achieve advantageous flow properties of the fluid flowing through. Thus, the opening of the throttling location can be milled or punched from the material of the bushing.

According another aspect of the invention a connecting rod is proposed for a variable compression internal combustion engine with an eccentrical element adjustment arrangement for adjusting an effective connecting rod length wherein the eccentrical element adjustment arrangement includes at least a first cylinder and a second cylinder wherein a respective inlet for feeding hydraulic fluid into the cylinders and a respective outlet for draining the hydraulic fluid from the cylinders are provided. The connecting rod includes a hydraulic arrangement comprising at least one switch valve for controlling a hydraulic fluid flow of the connecting rod wherein the switch valve includes a movable piston which is optionally displaceable into a first switching or a second switching position. In the first switching position the outlet of the first cylinder is connected through a switch valve with a hydraulic supply, and in the second switching position the outlet of the second cylinder is connected through the switch valve with the hydraulic supply. The cylinders are respectively associated with a check valve which facilitates feeding hydraulic fluid into the cylinders and prevents draining the hydraulic fluid from the cylinders. At least one respective filter element is arranged between the check valve and the hydraulic supply.

The check valves and the switch valve of the eccentrical element adjustment arrangement of the connecting rod can be arranged in a bearing shell of the connecting rod. A respective conduit runs to the support cavities wherein the conduit can be an inlet conduit and an outlet conduit at the same time. The connection to the oil supply through the bearing shell can be provided e.g. through a sickle groove in the connecting rod cover which can be connected through two boreholes with the hydraulic system in the connecting rod. The two boreholes establish a connection to return superfluous oil, e.g., during shifting processes into the oil gallery or to feed fresh oil into the system, e.g., during shifting processes or when there is leakage. The arrangement of a filter element at these two locations is advantageous so that no contamination moves from the connecting rod into the internal combustion engine but vice versa also so that no particles, e.g., from abrasion, move from the internal combustion engine into the sensitive hydraulic system of the connecting rod.

According to an advantageous embodiment the filter element can include a respective bushing which is flowable by a hydraulic fluid along a fluid path and at least one screen insert which is arranged in the fluid path of the bushing. Advantageously the screen insert is introduced into the bushing in order to provide an effective filter element in the fluid path of the eccentrical element adjustment arrangement of the connecting rod. The screen insert can be a sheet metal component that is flowed through by a hydraulic fluid like, e.g., motor oil, in both directions transversal to a surface of the screen insert. Thus, the oil is filtered in the interface between the connecting rod and the crank pin of the internal combustion engine. Thus, the eccentrical element adjustment arrangement can be protected against contamination from the crankshaft area of the internal combustion engine and the internal combustion engine can be protected against abrasion particles from the eccentrical element adjustment arrangement which can achieve a high service life of the connecting rod as well as of the internal combustion engine.

The screen insert can be configured for example as a perforated sheet metal plate wherein the holes can be introduced by laser processing. The screen insert can also be produced as a wire mesh web or as an injection molded plastic component with an insert made from wire mesh.

The screen insert can be pressed, snap locked or threaded into the bushing or can be attached in another suitable manner. A lug can be advantageously provided on an outside of the bushing for snap locking. Should a press fit not be suitable for tolerance reasons the screen insert, however, can also be welded into the bushing.

The filter element can be inserted as a complete sub assembly e.g. into a connecting rod cover of the connecting rod, e.g. pressed in or threaded in.

Since the screen insert can be flowed through by the oil in both directions and thus is flushed over and over again the filter element is configured self-purging.

According to an advantageously embodiment the cylinders can be connected so that hydraulic fluid is conductible in the first switching position from the first cylinder into the second cylinder. This way a quick switching of the eccentrical element adjustment arrangement can be performed from a position with a high compression ratio to a position with a low compression ratio.

According to an advantageous embodiment hydraulic fluid is conductible in the second switching position from the second cylinder into the first cylinder. This way a quick switching of the eccentrical element adjustment arrangement can be provided from a position with a low compression ratio to a position with high compression ratio.

According to an advantageous embodiment the inlet and the outlet of a cylinder can be configured at least partially as a single conduit. This saves a separate conduit for the inlet and the outlet which advantageously simplifies fabrication of the connecting rod. Also this way the engineering design of the common inlet bore hole and outlet bore hole can be configured simpler.

According to an advantageous embodiment the drain of the second cylinder can include at least one throttling location, this way a hydraulic preload of the second cylinder can be advantageously provided since the oil drains more slowly so that an adjustment speed of the eccentrical element adjustment arrangement is limited.

The speed driven acceleration of the relatively long hydraulic fluid columns in the cylinders of the connecting rod generate pressure differences. These pressure differences can have a positive effect as well as a negative effect, this means the hydraulic fluid columns can be accelerated so that emptying and filling the chambers is supported but also so that the emptying and the filling is impeded. In particular on the MKS side this effect can have a negative impact. The acceleration of the hydraulic fluid columns can have the effect that no positive pressure differential is formed in front of and behind the MKS side check valve, wherein the pressure difference facilitates conducting the hydraulic fluid into the MKS chamber. Since the chambers always lose hydraulic fluid by leakage and other effects the incremental slow adjustment of the eccentrical element over several revolution and thus of the effective connecting rod length from a low compression position ε_{low} into the high compression position ε_{high} causes drifting. This occurs in particular in engine load cases with high mass forces (tension force and compression force at the connecting rod) and low gas forces (compression force at the connecting rod). A possible adjustment of the connecting rod towards the high compression position ε_{high} by the mass forces in tension direction cannot be reset completely by the mass forces in compression direction and the gas forces. This is caused by the GKS chamber conducting its received hydraulic fluid directly and without throttling into the MKS chamber in the low compression position ε_{low}. The hydraulic fluid which is conducted from the GKS chamber into the MKS chamber by gas forces impacting the connecting rod and by mass forces acting in the compression direction has a much higher pressure in most engine operating points, than the hydraulic pressure in the hydraulic supply in the bearing shell. Thus, the hydraulic fluid can be pressed from the GKS chamber into the MKS chamber and the MKS chamber is hydraulically preloaded.

In addition to the overall bearing stability in the low compression position ε_{low}, this means after one revolution the connecting rod is in its low compression end position ε_{low} again, also the position stability over the revolution, this means the stiffness of the connecting rod, will increase.

During a revolution there always is a lever movement since the hydraulic fluid columns have a certain amount of flexibility and there is always some amount of sinking of the support piston into the filled chamber. If the connecting rod resets completely again when the revolution is completed this is called “position stable”. However, an angle change at the eccentrical element/lever assembly is not desirable since the respective support piston can impact the base of the chamber during resetting. The adjustment speed can thus be advantageously limited by the aperture bore holes of the throttling locations. A pressurized and preloaded hydraulic fluid column sinks less than a non-preloaded hydraulic fluid column. Less sinking means less lever movement so that the position stability can be improved in the low compression position ε_{low}.

According to an advantageous embodiment one individual check valve can be respectively associated with each cylinder. The check valve advantageously prevents uncontrolled draining of oil from the filled cylinder. Also this way a controlled inflow of oil can be provided through the desired inlet channel.

According to an advantageous embodiment a throttling location can be arranged in a supply conduit of the second cylinder. This way a hydraulic preload of the second cylinder can be advantageously provided since feeding the oil from the second cylinder is performed in a throttled manner so that an adjustment speed of the eccentrical element adjustment is limited.

According to an advantageous embodiment the throttling location can be integrated in the filter element. The throttling location can be implemented for example as a constriction of the free cross section of the bushing of the filter element. The throttling location can also be configured as a conical aperture in an interior of the bushing in order to obtain advantageous flow properties of the fluid flowing through. Thus, the opening of the throttling location can be milled or stamped out of the material of the bushing.

According to an advantageous embodiment a hydraulic connection for filling the second cylinder from the first cylinder can be configured unthrottled. Thus, a quicker filing of the second cylinder with hydraulic fluid is provided so that a switching from one switching poison to another switching position of the connecting rod can be performed more quickly.

According to an advantageous embodiment the switch valve can include at least one valve element and the movable piston as a capture element, wherein the movable piston is displaceable into a first switching position or a second switching position. Thus, at least a first operating connection is connected with a first supply connection in the first switching position and at least a second operating connection is connected with a second supply connection in the second switching position. Through the switch valve a reliable and quick switching of the eccentrical element adjustment arrangement of the connecting rod can be performed from a high compression position to a low compression position. The switch valve can be configured mechanically or hydraulically actuatable.

### BRIEF DESCRIPTION OF THE DRAWINGS

Further advantages can be derived from the subsequent drawing description. The drawing illustrate an embodiment of the invention. The drawings, the description and the claims include several features in combination. A person skilled in the art will advantageously view the features also individually and will combine them into additional useful combinations, wherein:

FIG. 1 illustrates a front view of a connecting rod according to the invention in a first switching position with sectional planes B-B, C-C, D-D designated;

FIG. 2 illustrates a side view of the connecting rod partially cut in the sectional plane D-D according to FIG. 1 with sectional planes A-A, E-E, and F-F designated;

FIG. 3 illustrates a longitudinal sectional view of the connecting rod in the sectional plane A-A according to FIG. 1;

FIG. 4 illustrates a longitudinal sectional view of the connecting rod in the sectional plane E-E according to FIG. 1;

FIG. 5 illustrates a longitudinal sectional view of the connecting rod in the sectional plane F-F according to FIG. 1;

FIG. 6 illustrates a cross sectional view of the connecting rod in the sectional plane C-C according to FIG. 1;

FIG. 7 illustrates a cross sectional view of the connecting rod in the sectional plane B-B according to FIG. 1;

FIG. 8 illustrates a blown up detail Z of the cross section C-C;

FIG. 9 illustrates a blown up detail Y of the cross sectional B-B;

FIG. 10 illustrates an exploded view of a first filter element according to an embodiment of the invention; and

FIG. 11 illustrates an exploded view of a second filter element according to another embodiment of the invention.

### DETAILED DESCRIPTION OF THE INVENTION

In the drawing figures identical or like components are labelled with identical reference numerals. The figures merely illustrate exemplary embodiments and do not limit the scope of the invention.

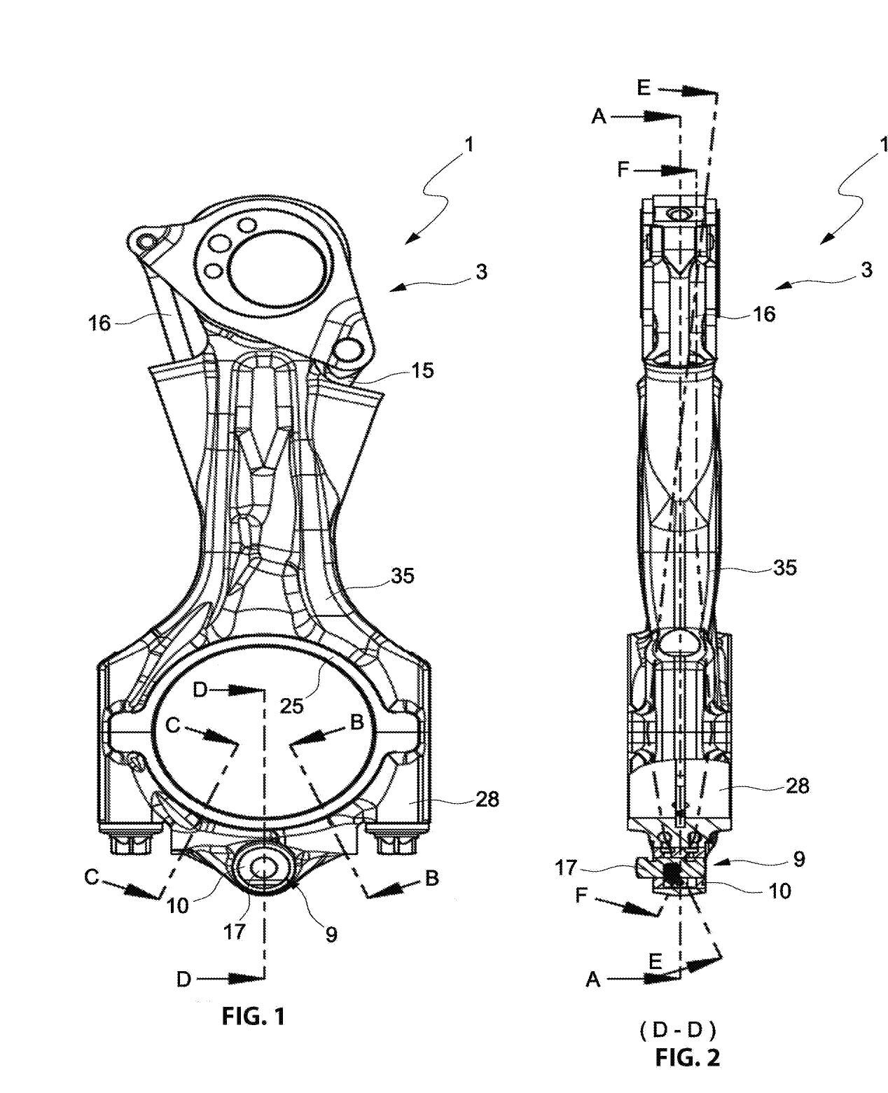

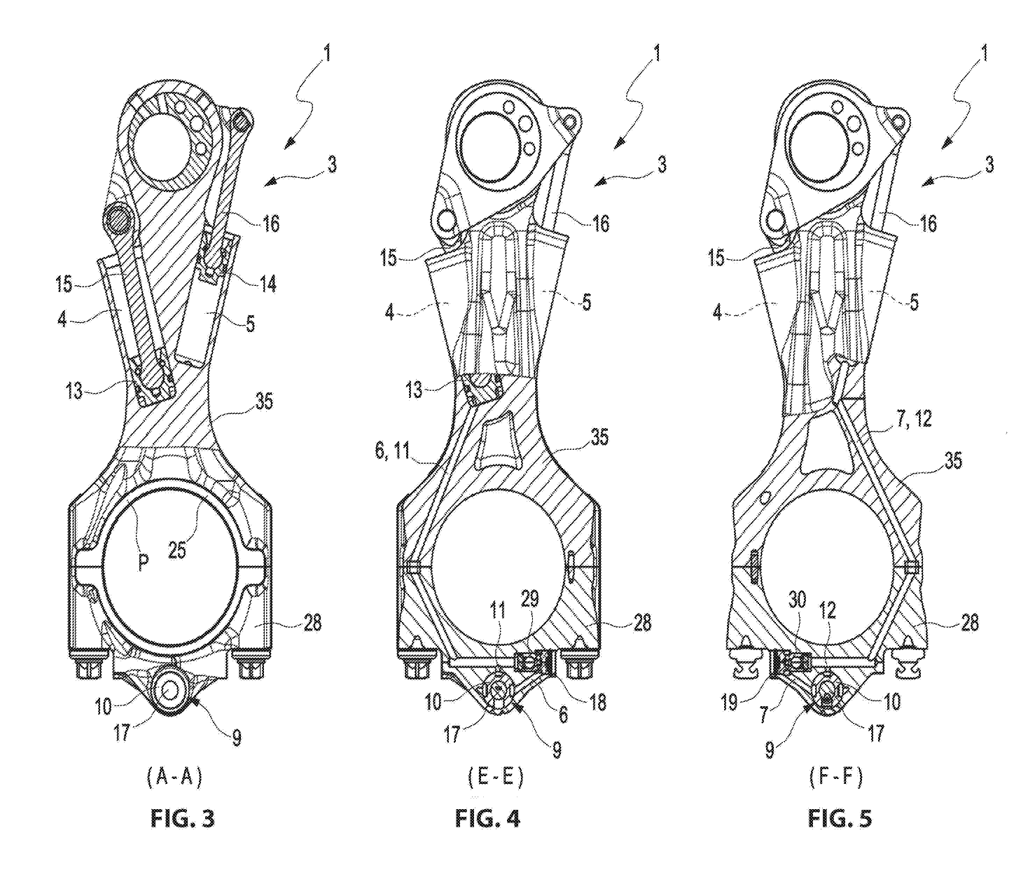

FIGS. 1-5 illustrate a connecting rod 1 for a variable compression internal combustion engine in various views and sectional views. A hydraulic arrangement of the connecting rod 1 includes a switch valve 9 for controlling a hydraulic fluid flow of the connecting rod 1 with an eccentrical element adjustment arrangement 3 for adjusting an effective connecting rod length. As evident from FIG. 3 the eccentrical element adjustment arrangement 3 includes at least a first cylinder 4 and a second cylinder 5 wherein a respective inlet 6, 7 for feeding hydraulic fluid into the cylinders 4, 5 as well as a respective outlet 11, 12 for draining hydraulic fluid from the cylinder 4, 5 are provided as illustrated in FIGS. 4 and 5. The switch valve 9 as evident from the sectional view in FIG. 4 includes at least one valve element 10 and a movable piston 17 configured as a capture element which is displaceable into a first switching position S1 or a second switching portion S2 wherein the outlet 11 of the first cylinder 4 is connected through the switch valve 9 with a hydraulic supply P, thus with a bearing shell 25 of the connecting rod 1 (c.f. FIG. 3) and in the second switching position S2 the outlet 12 of the second cylinder 5 is connected through the switch valve 9 with the hydraulic supply P, thus with the bearing shell 25 of the connecting rod 1 (c.f. FIG. 3).

According to the illustrated advantageous embodiment the eccentrical element adjustment arrangement 3 can have two cylinders 4, 5 respectively with a piston 13, 14 that is movably supported in a cylinder bore hole and connected with a support rod 15, 16.

Thus, the cylinder 4 is a hydraulic chamber on the gas force side (GKS) of the connecting rod 1, whereas the cylinder 5 represents a hydraulic chamber on the mass force side MKS of the connecting rod 1.

The cylinders 4, 5 are respectively associated with a check valve 18, 19 which facilitates feeding hydraulic fluid into the cylinders 4, 5 and prevents a draining of the hydraulic fluid from the cylinders 4, 5.

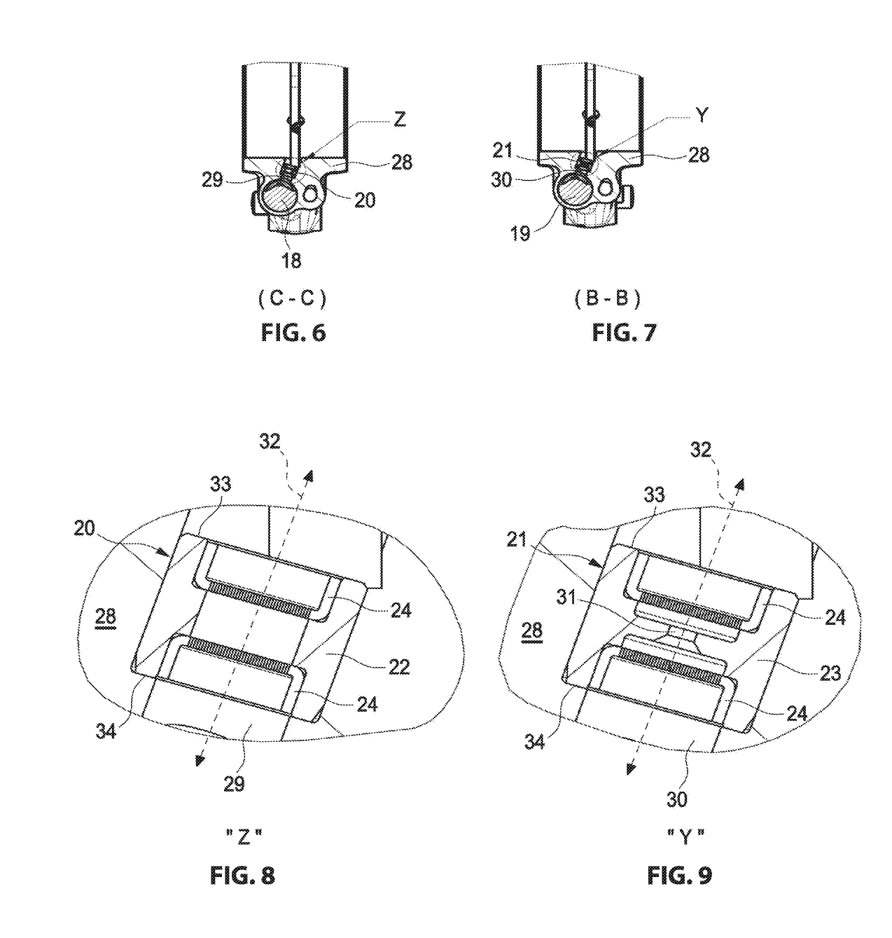

As can be derived from FIGS. 6 and 7 and in particular from the enlarged details of FIGS. 8 and 9 a first or a second filter element 20, 21 is arranged in a supply conduit 29, 30 respectively between the check valve 18, 19 and the hydraulic supply P wherein superfluous hydraulic fluid is run through the supply conduit 29, 30 back into the hydraulic supply P, e.g. during switching processes and through which additional hydraulic fluid can be fed from the hydraulic supply P into the hydraulic system when there is leakage or during switching processes. The filter element 20, 21 includes a bushing 22, 23 which is flowable by a hydraulic fluid along a fluid path 32 and two screen inserts 24 which are arranged in the fluid path 32 of the bushing 22, 23. The screen insert 24 is respectively arranged at a face 33, 34 of the bushing 22, 23. The bushing 23 includes a throttling location 31 along the fluid path 32 wherein the throttling location is integrated into the bushing 23. The throttling location 31 is positioned in the drain 12 of the cylinder 5 through this arrangement of the filter element 21.

The inlet 6, 7 and the outlet 11, 12 of a cylinder 4, 5 (c.f. FIGS. 4, 5) respectively lead in a common conduit into the cylinder 4, 5. Advantageously only two check valves 18, 19 are required according to the invention. Additional check valves do not have to be provided. Thus, the chambers 4, 5 are connected so that hydraulic fluid can be conducted from the GKS chamber 4 in the illustrated low compression position ε_{low} directly and without throttling into the MKS chamber 5.

As evident e.g. from the drawing figures the switch valve 9 and the two check valves 18, 19 are arranged in a connecting rod cover 28 below the bearing shell 25 and connected through hydraulic conduits with the cylinders 4, 5 and the hydraulic supply P through the bearing shell 25. The switch valve 9, however, can be arranged as a matter of principle at any location in the connecting rod 1, this means also in the connecting rod body 35.

The speed driven acceleration of the rather long hydraulic fluid columns arranged in the cylinders 4, 5 of the connecting rod 1 generate pressure differences. The pressure differences can have a positive effect as well as a negative effect, this means the hydraulic fluid columns can be accelerated so that emptying and filling of the chambers 4, 5 is supported but also so that the emptying and filling of the chambers 4, 5 is impeded. This effect can have negative consequences in particular on the MKS side. The acceleration of the hydraulic fluid columns can have the effect that no positive pressure differential is formed any more in front of and behind the MKS side check valve 19, wherein the pressure differential has the effect that hydraulic fluid can be conducted into the MKS chamber 5. Since the chambers 4, 5 always lose hydraulic fluid through leakage and other effects this causes an incremental slow adjustment of the eccentrical element over plural revolutions and thus a change of the effective length of the connecting rod 1 from the low compression position ε_{low} into the high compression position ε_{high} which is called drifting. This occurs for example in engine load cases with high mass forces (tension force and compression force at the connecting rod 1) and low gas forces (compression force at the connecting rod 1). A possible adjustment of the connecting rod 1 towards the high compression position ε_{high} through mass forces in tension direction cannot be reset completely by the mass forces in the compression direction and the gas forces. This is performed in that the GKS chamber 4 in the low compression position ε_{low} conducts received hydraulic fluid directly and without throttling into the MKS chamber 5. The hydraulic fluid that is conducted by the GKS chamber 4 through gas forces and mass forces in compression direction impacting the connecting rod 1 into the MKS chamber 5 has a much higher pressure in most engine operating points, than the hydraulic pressure in the hydraulic supply P of the bearing shell 25. Thus, the hydraulic fluid can be pressed from the GKS chamber 4 into the MKS chamber 5 and the MKS chamber 5 is hydraulically preloaded.

In addition to the universal position stability in the low compression position ε_{low}, this means after one revolution, the connecting rod 1 is in its low pressure end position ε_{low} again, the position stability over the revolution or the stiffness of the connecting rod 1 will increase as well.

During a revolution there is always a lever movement since the hydraulic fluid conduits also have a particular flexibility so that a particular sinking of the support piston into the fill chamber 4, 5 always occurs. When the connecting rod 1 resets completely at an end of the revolution this is designated as “position stable”. However, an angle change at the eccentrical element/lever assembly is not desirable since a respective support piston can impact a base of the chamber during resetting. The adjustment speed can thus be advantageously limited by the aperture boreholes of throttling locations. A pressure preloaded MKS hydraulic fluid column sinks less than a non-preloaded hydraulic fluid column. Less sinking means less lever movement which can improve position stability in the low compression position ε_{low}.

The hydraulic conduit from the GKS chamber 4 towards the bearing shell 25 with a throttling location is advantageous since the chambers 4, 5 have different sizes, this means the volume difference from the larger GKS chamber 4 that is not received by the MKS chamber 5 can be drained towards the bearing shell 25 since the GKS chamber 4 would otherwise always fill up and the eccentrical element adjustment arrangement would always move into the high compression position ε_{high} irrespective of the position of the switch valve. Thus, a hydraulic pressure is built up in front of the hydraulic supply P of the bearing shell 25 and thus also in front of the check valve 19. Through a forced connection of the two support pistons (GKS piston and MKS piston) through the lever assembly a differential volume flow in the low compression position ε_{low} that flows towards the bearing shell 25 can be advantageously throttled to limit the adjustment velocity of the GKS piston since the MKS chamber 5 cannot receive the entire volume of the hydraulic fluid that is provided by the GKS chamber 4. Thus, a throttling causes a braking of the GKS piston which generates a corresponding pressure in front of the check valve 19 of the MKS chamber 5 so that the MKS chamber 5 can be filled reliably in the first switching position S1.

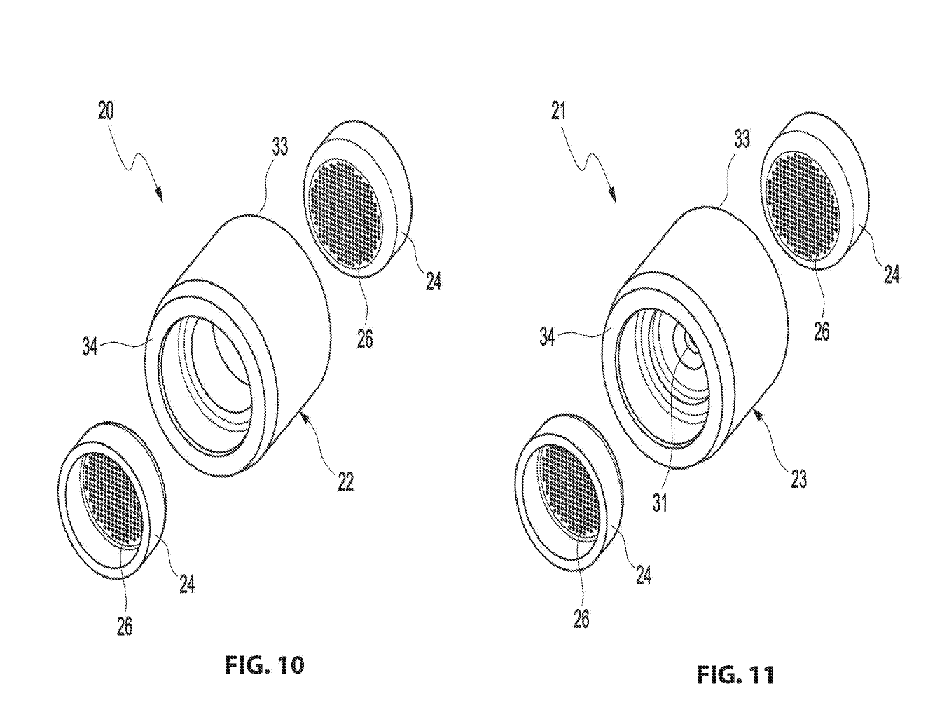

The filter elements 20, 21 are illustrated blown up in FIGS. 8 and 9 and 10 and 11. The filter elements respectively include a bushing 22, 23 into which two identically configured screen inserts 24 are introduced. Advantageously the screen inserts 24 are also configured as sheet metal deep drawn components wherein the holes 26 can be introduced by a laser. The bushing 22, 23 can be arranged in the connecting rod 1 by a press fit secured against dropping out. Alternatively the bushing 22, 23 can be threaded or welded into the connecting rod 1.

A throttling location 31 described supra can be advantageously integrated into the corresponding filter element directly in that the throttling location is configured in the bushing 23.

Arranging two respective screen inserts 24 is advantageous in particular in that neither contaminant particles from the internal combustion engine can penetrate into the connecting rod 1 nor contaminant particles from the connection rod 1 can penetrate into the internal combustion engine.

What is claimed is:

1. A filter element for a connecting rod including an eccentrical element adjustment arrangement for adjusting an effective connecting rod length, the filter element comprising:
a bushing that is flowable by a hydraulic fluid along a fluid path; and
at least one screen insert that is arranged in the fluid path of the bushing.

2. The filter element according to claim 1, wherein the at least one screen insert is arranged at a face of the bushing.

3. The filter element according to claim 1, wherein the bushing includes a throttling location along the fluid path.

4. The filter element according to claim 3, wherein the throttling location is integrated into the bushing.

5. A connecting rod for a variable compression internal combustion engine, the connecting rod comprising:
an eccentrical element adjustment arrangement for adjusting an effective connecting rod length, the eccentrical element adjustment arrangement including at least a first cylinder and a second cylinder, a first inlet for feeding hydraulic fluid into the first cylinders and a first outlet for draining the hydraulic fluid from the first cylinder and a second inlet for feeding hydraulic fluid into the second cylinder and a second outlet for draining the hydraulic fluid from the second cylinder;
a hydraulic arrangement including at least one switch valve for controlling a hydraulic fluid flow of the connecting rod wherein the at least one switch valve includes a movable piston which is displaceable into a first switching or a second switching position, wherein the outlet of the first cylinder is connected through the at least one switch valve with a hydraulic supply in the first switching position and the outlet of the second cylinder is connected through the at least one switch valve with the hydraulic supply in the second switch position,
wherein the first cylinder is associated with a first check valve and the second cylinder is associated with a second check valve which facilitates feeding hydraulic fluid into the first cylinder and the second cylinder and prevents draining of the hydraulic fluid from the first cylinder and the second cylinder, and
wherein at least one filter element according to claim 1 is arranged between the first check valve and the hydraulic supply and between the second check valve and the hydraulic supply.

6. The connecting rod according to claim 5, wherein the at least one filter element includes a bushing which is flowable along a hydraulic fluid along a fluid path and at least one screen insert which is arranged in the fluid path of the bushing.

7. The connecting rod according to claim 5, wherein the first cylinder and the second cylinder are connected so that hydraulic fluid is conductible in the first switching position from the first cylinder into the second cylinder.

8. The connecting rod according to claim 5, wherein hydraulic fluid is conductible in the second switching position from the second cylinder into the first cylinder.

9. The connecting rod according to claim 5, wherein the inlet of the first cylinder and the outlet of the first cylinder or the inlet of the second cylinder and the outlet of the second cylinder are at least partially formed as a single conduit.

10. The connecting rod according to claim 5, wherein the outlet of the second cylinder includes at least one throttling location.

11. The connecting rod according to claim 5, wherein the first cylinder is associated with a single check valve and the second cylinder is associated with a single check valve.

12. The connecting rod according to claim 5, wherein a throttling location is arranged in a supply conduit of the second cylinder.

13. The connecting rod according to claim 12, wherein the throttling location is integrated into the filter element.

14. The connecting rod according to claim 5, wherein a hydraulic connection for filling the second cylinder from the first cylinder is provided unthrottled.

15. The connecting rod according to claim 5,
wherein the switch valve includes at least one valve element and a movable piston as a capture element,
wherein the movable piston is displaceable into a first switching position or a second switching position,
wherein at least a first operating connection is connected with a first supply connection in the first switching position and at least a second operating connection is connected with a second supply connection in the second switching position.
